(19) United States
(12) Patent Application Publication
(10) Pub. No.: US 2026/0254959 A1
(43) Pub. Date: Aug. 27, 2026

(54) SIGNALING PARTITIONING INFORMATION FOR VIDEO AND IMAGE CODING

(71) Applicant: MEDIATEK INC., Hsinchu City (TW)

(72) Inventors: Shih-Ta HSIANG, Hsinchu City (TW); Tzu-Der CHUANG, Hsinchu City (TW)

(21) Appl. No.: 19/160,180

(22) PCT Filed: Apr. 24, 2024
(86) PCT No.: PCT/CN2024/089470

§ 371 Date: Aug. 27, 2025

Related U.S. Application Data
(60) Provisional application No. 63/497,762, filed on Apr. 24, 2023.

(51) Int. Cl. H04N 19/119; H04N 19/13; H04N 19/176; H04N 19/196; H04N 19/70

(52) U.S. Cl. CPC H04N 19/119; H04N 19/13; H04N 19/176; H04N 19/196; H04N 19/70

(57) ABSTRACT

A method for signaling block partitioning structure information when coding pixel blocks is provided. A video coder receives data to be encoded or decoded as a current block of pixels of a current picture of a video. The video coder encodes or decodes the current block based on a block partitioning information. The video coder entropy encodes or decodes one or more syntax elements specifying the block partitioning information of the current block, wherein the entropy coding is performed based on information regarding one or more reference regions of the current block. The reference regions may include one or more spatial neighboring blocks, spatial non-adjacent blocks, or collocated temporal reference blocks in one or more reference pictures. The entropy coding maybe performed based on information regarding the reference regions of the current block, and with context modeling selected based on the information regarding the reference regions.

### CROSS REFERENCE TO RELATED PATENT APPLICATION(S)

The present disclosure is part of a non-provisional application that claims the priority benefit of U.S. Provisional Patent Application No. 63/497,762 filed on 24 Apr. 2023. Content of above-listed applications is herein incorporated by reference.

### TECHNICAL FIELD

The present disclosure relates generally to video coding. In particular, the present disclosure relates to methods of coding pixel blocks by signaling partitioning information.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

A method for signaling block partitioning structure information when coding pixel blocks is provided. A video coder receives data to be encoded or decoded as a current block of pixels of a current picture of a video. The video coder encodes or decodes the current block based on a block partitioning information. The video coder entropy encodes or decodes one or more syntax elements specifying the block partitioning information of the current block. The entropy coding may be performed based on information regarding one or more reference regions of the current block. The one or more syntax elements may be entropy coded with context modeling selected based on the information regarding the one or more reference regions.

The reference regions may include one or more blocks that spatially neighbor the current block, or blocks that are in the current picture but not adjacent to the current block, or collocated temporal reference blocks in one or more coded reference pictures. These reference regions may correspond to merge candidates of the current block. The identified reference regions may or may not be used for motion compensation or other predictive coding of the current block.

The block partitioning related syntax element being entropy coded may be one that is used to indicate whether the current block (e.g., CU) is further partitioned (e.g., split_cu_flag) or is used to indicate whether the current block is further partitioned by a quad tree (QT) split or a multi-type tree split (MTT) (e.g., split_qt_flag.) The syntax element may be entropy coded with context modeling selected based on QT or MTT split depth statistics, or based on a comparison of a QT depth of the current block with a minimum, a maximum, or an average of QT depths of the one or more reference regions, or based on a comparison of a QT depth of the current block with a QT depth of a collocated temporal reference block, or based on blocks sizes of one or more temporal reference regions.

The block partitioning related syntax element being entropy coded may also be one that is used to indicate whether a current CU is further partitioned by a vertical split or a horizontal split (e.g., split_vertical/horizontal_flag.) The syntax element may be entropy coded with context modeling selected based on information regarding block shapes, split directions, or block sizes of one or more temporal reference block regions, or based on whether vertical split or horizontal split is ever applied in one or more temporal reference regions.

The block partitioning related syntax element (or elements) being entropy coded may also be used to indicate a set of partitioning constraint parameters that is enforced upon the block partitioning structure of the current block. The syntax elements may be entropy coded with context modeling selected based on partitioning constraint parameters of the one or more spatial or temporal reference regions. In some embodiments, the set of partitioning constraint parameters of the current block may be derived based on block partitioning information of the one or more spatial or temporal reference regions.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 provides an example CTU that is recursively partitioned by quadtree (QT) partitioning with nested multi-type tree (MTT) partitioning.

FIG. 2 illustrates the five split types of a coding unit, including by QT partitioning and by MTT partitioning.

FIG. 3 illustrates the signaling mechanism of the partition splitting information.

FIG. 4 conceptually illustrates reference block regions that are used to derive or signal block partitioning information of the current block.

FIG. 5 illustrates an example video encoder that may signal block partition information based on reference regions information.

FIG. 6 illustrates portions of the video encoder that signals block partition information based on reference region information.

FIG. 7 conceptually illustrates a video encoding process that signals block partition information based on reference region information.

FIG. 8 illustrates an example video decoder that may signal block partitioning information based on reference regions information.

FIG. 9 illustrates portions of the video decoder that receives block partition information based on reference regions information.

FIG. 10 conceptually illustrates a video decoding process that receives block partition information based on reference region information.

FIG. 11 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Constraint Parameters for Block Partitioning

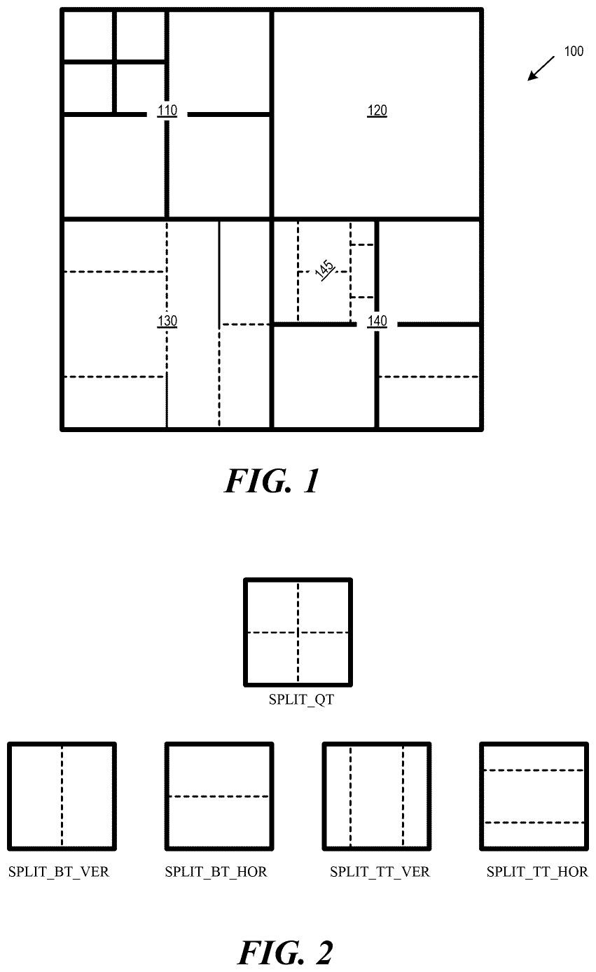

A CTU can be partitioned into one or multiple non-overlapped coding units (CUs) using the quadtree (QT) with nested multi-type-tree (MTT) structure to adapt to various local motion and texture characteristics. FIG. 1 provides an example CTU 100 that is recursively partitioned by QT with nested MTT. In the figure, the bold solid edges represent quadtree partitioning and the broken edges represent multi-type tree (MTT) partitioning. As illustrated, the CTU 100 is partitioned by QT into CUs 110, 120, 130, and 140. The CU 110 is further partitioned by QT. The CU 120 is not further partitioned. The CU 130 is further partitioned by MTT. The CU 140 is further partitioned by QT and then by MTT.

FIG. 2 illustrates the five split types of a CU, including by QT partitioning and by MTT partitioning. As illustrated, the CU can be further split into smaller CUs by using QT partitioning (SPLIT_QT), or by using one of the four MTT partitioning types: vertical binary partitioning (SPLIT_BT_VER), horizontal binary partitioning (SPLIT_BT_HOR), vertical ternary partitioning (SPLIT_TT_VER), horizontal ternary partitioning (SPLIT_TT_HOR).

The following are partitioning constraint parameters defined for the quadtree with nested multi-type tree coding tree scheme. These constraint parameters may be specified by sequence parameter set (SPS) syntax elements and can be further refined by picture header syntax elements.
CTUsize: the root node size of a quaternary tree
MinQTSize: the minimum allowed quaternary tree leaf node size
MaxBtSize: the maximum allowed binary tree root node size
MaxTtSize: the maximum allowed ternary tree root node size.
MaxMttDepth: the maximum allowed hierarchy depth of multi-type tree splitting from a quadtree leaf
MinCbSize: the minimum allowed coding block node size

The values of constraint parameters for partitioning CUs may be signaled in the SPS and can be overridden by the picture header (PH) of a current picture. The signaled set of constraint parameters may be applied to the entire current picture for partitioning each CTU into one or more CUs.

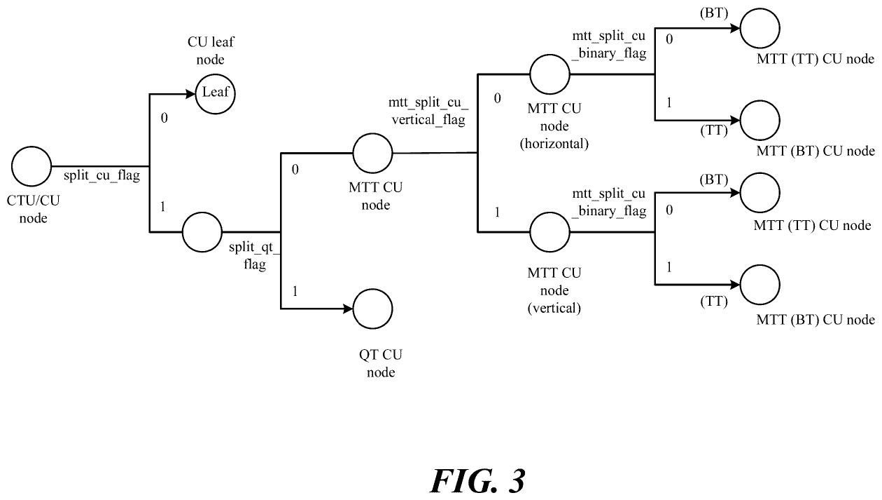

A coding tree unit (CTU) is treated as the root of a quaternary tree (or quadtree) and is first partitioned by a quaternary tree structure. Each quaternary tree leaf node (when sufficiently large to allow it) is then further partitioned by a multi-type tree structure. FIG. 3 illustrates the signaling mechanism of the partition splitting information, specifically for quadtree with nested multi-type tree coding tree structure. The figure illustrates splitting flags that are used to indicate the partition tree structure of a block. Specifically, a first flag (mtt_split_cu_flag) is signalled to indicate whether the node is further partitioned; when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as below:

| | mtt_split_cu_{—} | mtt_split_cu_{—} |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

### II. Block Partitioning Information Based on Reference Block Regions

In some embodiments, a set of constraint parameters enforced for partitioning a current block region into one or more coding blocks can be derived or adaptively adjusted based on block partition information of one or more reference block regions from one or more spatial neighboring blocks in a current picture and/or one or more temporal corresponding blocks in one or more coded reference pictures.

A video coder may derive the updated values for the set of constraint parameters for partitioning the current block region based on the partition information for one or more coded reference block regions. In this way, the constraint parameters enforced for partitioning each block region may be efficiently adjusted according to the contents of local image or video regions.

In some embodiments, the current block region may correspond to a coding tree unit or a coding unit. In some embodiments, the spatial neighboring reference blocks may include one above neighboring block and the left neighboring block. In some embodiments, the spatial neighboring reference blocks may further include the top-right neighboring block and the top-left neighboring block of the current block. In some embodiments, the reference blocks may further include some spatially non-adjacent CTUs from the coded regions in a current picture. In some embodiments, the temporal reference blocks are one or more collocated blocks with or without motion compensation in one or more pictures in the current reference picture list. In some embodiments, the selected reference picture is a collocated picture specified for the current input picture. When the current block region corresponds to a coding tree unit, the temporal reference block may be the collocated CTU in the selected reference picture. When the current block region corresponds to a coding unit, the temporal reference block may be the collocated CTU or one or more block regions in the selected reference picture.

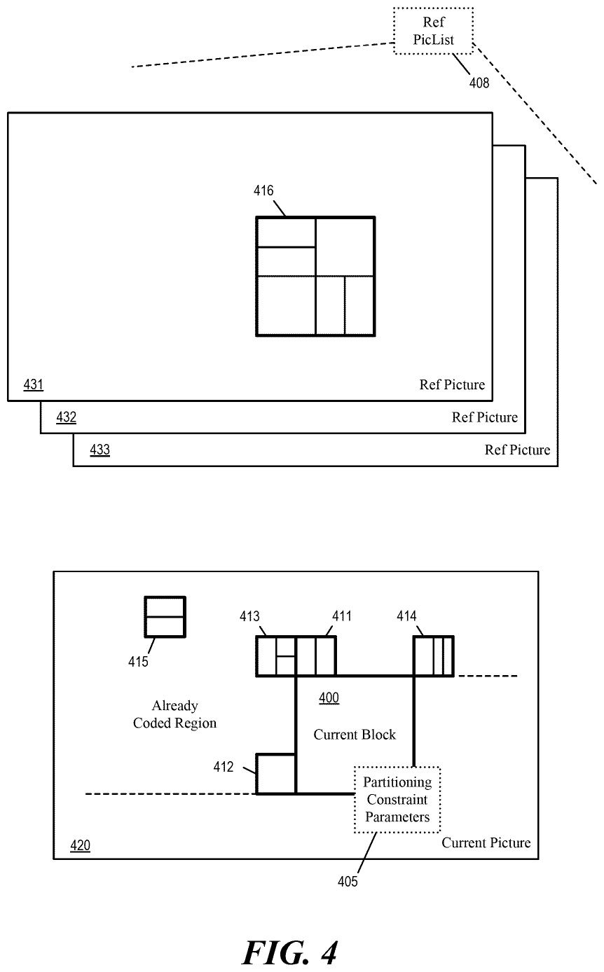

FIG. 4 conceptually illustrates reference block regions that are used to derive or signal block partitioning information of the current block. The figure illustrates a current block 400 that may be partitioned subject to a set of partitioning constraint parameters 410. The current block 400 is in a current picture 420. The figure illustrates several block regions 411-416 that may be used as reference block regions for the purpose of deriving a set of partitioning constraint parameters 405 for the current block 400. These reference block regions may be CTUs or CUs or any other types of pixel blocks. The reference block regions may themselves be partitioned according to their own partitioning structures and partitioning constraint parameters.

The reference locks 411-414 are already-reconstructed spatial neighbors of the current block 400. Among these, the block 411 is an above spatial neighboring block, the block 412 is a left spatial neighboring block, the block 413 is a left-above spatial neighboring block, the block 414 is a right-above spatial neighboring block. The reference block 415 is also in the already reconstructed region of the current picture 420, but spatially non-adjacent to the current block 400. These spatial reference blocks can be used as reference block regions for the purpose of deriving the set of partitioning constraint parameters 405.

The reference block 416 is a temporal reference block located in a temporal reference picture 431 and not in the current picture 420. This temporal reference block 416 may be a collocated block in a picture in a current reference picture list, regardless of whether or not the block 416 is referenced by a motion vector for motion compensation. Temporal reference blocks can also be used as a reference block for the purpose of deriving the set of partitioning constraint parameters 405.

Information about the reference blocks 411-415, such as their partitioning constraint parameters, partitioning structures (e.g., MTT/QT/BT/TT settings), quantization parameters, block sizes, etc., can be used by video coder to set or adjust the partitioning constraint parameters of the current block 400. The set of partitioning constraint parameters may include MinQtSize, MaxBtSize, MaxTtSize, MaxMttDepth, MinCbSize, MaxQtDepth, MinQtDepth, MinWidth, MinHeight, BtEnabedFlag, TtEnabledFlag, HorEnabledFlag, VerEnabledFlag, or a combination thereof, with semantics defined according to Table 1 below:

TABLE 1

| | |
|---|---|
| MinQtSize | Minimum allowed size (width or height) of a quadtree leaf in the |
| | current block region |
| MaxBtSize | Maximum allowed size (width or height) of a coding block that |
| | can be split by a BT split in the current block region. |
| MaxTtSize | Maximum allowed size (width or height) of a coding block that |
| | can be split by a TT split in the current block region |
| MaxMttDepth | Maximum allowed depth of a coding block resulting from multi- |
| | type tree splitting of a quadtree leaf in the current block region |
| MinCbSize | Minimum allowed size (width or height) of a coding block in the |
| | current block region |
| MinQtDepth | Minimum allowed quadtree tree depth of a coding block in the |
| | current block region starting from the current CTU |
| MaxQtDepth | Maximum allowed quadtree tree depth of a coding block in the |
| | current block region starting from the current CTU |
| MinWidth | Minimum allowed partition width in the current block region |
| MinHeight | Minimum allowed partition height in the current block region |
| BtEnabledFlag | =1: BT split is enabled in the current block region |
| | =0: BT split is disabled in the current block region |
| TtEnabledFlag | =1: TT split is enabled in the current block region |
| | =0: TT split is disabled in the current block region |
| HorEnabledFlag | =1: horizontal split is enabled in the current block region |
| | =0: horizontal split is disabled in the current block region |
| VerEnabledFlag | =1: vertical split is enabled in the current block region |
| | =0: vertical split is disabled in the current block region |

The constraint parameters for the current block region may be derived or predicted by the partition information in the selected one or more reference blocks. For example, BtEnabedFlag and TtEnabedFlag for the current block may be determined considering partition information on BT and TT split statistics in the reference block(s). In some embodiments, BtEnabedFlag or TtEnabedFlag is set to 0 when a BT or TT split is not used in all selected one or more reference blocks. Similarly, HorEnabledFlag and VerEnabledFlag for the current block may be determined considering partition information on horizontal and vertical split statistics in the reference block(s). In some embodiments, HorEnabedFlag or VerEnabedFlag is set to 0 when a horizontal or vertical split is not used in all selected one or more reference blocks. In some embodiments, some variables can be further defined to characterize partition information in a coded block region, as shown in Table 2 below:

TABLE 2

| | |
|---|---|
| MinQtSizeUsed | Minimum size (width or height) of a quadtree leaf present in a |
| | block region |
| MaxBtSizeUsed | Maximum size (width or height) of a quadtree leaf that is first |
| | further split by a BT split in a block region |
| MaxTtSizeUsed | Maximum size (width or height) of a quadtree leaf that is first |
| | further split by a TT split in a block region |
| MaxMttDepthUsed | Maximum depth of a coding block resulting from multi-type tree |
| | splitting of a quadtree leaf in a block region |
| MinCbSizeUsed | Minimum size (width or height) of a coding block in a block region |
| MinQtDepthUsed | Minimum quadtree tree depth of a coding block in a block region |
| | starting from the current CTU |
| MaxQtDepthUsed | Maximum quadtree tree depth of a coding block in a block region |
| | starting from the current CTU |
| MinWidthUsed | Minimum width of a coding block in a block region |
| MinHeightUsed | Minimum height of a coding block in a block region |
| BtUsedFlag | =1: BT split is used for partitioning a current block region |
| | =0: BT split is not used for partitioning a current block region |
| TtUsedFlag | =1: TT split is used for partitioning the current block region |
| | =0: TT split is not used for partitioning the current block region |
| HorUsedFlag | =1: horizontal split is used for partitioning the current block |
| | region |
| | =0: horizontal split is not used for partitioning the current block |
| | region |
| VerUsedFlag | =1: vertical split is used for partitioning the current block region |
| | =0: vertical split is not used for partitioning the current block |
| | region |

In some embodiments, variables related to the statistics of a coded block region may also be utilized as constraint parameters for partitioning a current block region. For example, when HorUsedFlag equal to 1 is specified for a current block region, it is constrained that at least one block in the current block region shall be partitioned by a horizontal split.

In some embodiments, the constraint parameters for the current block region may be derived or predicted according to the related variables on partition statistics in the selected one or more reference blocks. For example, in some embodiments, the values of the constraint parameters for a current block region may be derived from the values of the corresponding variables in the selected reference block, as follows:

$${MaxMttDepth}_{cur} = {MaxMttDepthUsed}_{ref} + {T}_{maxMTD}$$

$${MaxQtDepth}_{cur} = {MaxQtDepthUsed}_{ref} + {T}_{maxQTD}$$

$${MinQtDepth}_{cur} = {MinQtDepthUsed}_{ref} + {T}_{minQTD}$$

where T_{maxMTD}, T_{minQTD}, T_{maxQTD} are offset values determined by some pre-defined rules. For another example, in some embodiments, the values of the constraint parameters for a current block region may be derived from the values of the corresponding variables in the selected reference block, as follows:

$$MinQtSizecur = MinQtSizeUsedref >> TminQTS ,$$

$$MaxBtSizecur = MaxBtSizeUsedref >> TmaxBTS ,$$

$$MaxTtSizecur = MaxTtSizeUsedred >> TmaxTTS ,$$

$$MinCbSizecur = MinCbSizeUsedref >> TminCS ,$$

$$MinWidthcur = MinWidthUsedref >> TminW ,$$

$$MinHeightcur = MinHeightUsedref >> TminH$$

wherein T_{minQTS}, T_{maxBTS}, T_{maxTTS}, T_{minCS}, T_{minW}, and T_{minH} are scaling factors determined by some pre-defined rules and “>>” indicates a bit-wise shift operation. A bitwise down-shift operation is performed when a scaling factor is a positive number, otherwise, a bitwise up-shift operation is performed.

In some embodiments, a video coder may utilize more than one reference block to derive or predict the constraint parameters for a current block region. For one example, a video coder may utilize partition statistics from one above neighboring reference block, refA, and one left neighboring reference block, refL, to derive or predict the constraint parameters for a current block region, as follows;

$${MaxMttDepth}_{cur} = Max ( {MaxMttDepthUsed}_{refA} , {MaxMttDepthUsed}_{refL} ) ,$$

$$MaxQtDepthcur = Max ( MaxQtDepthUsedrefA , MaxQtDepthUsedrefL )$$

$$MinQtDepthcur = Min ( MinQtDepthUsedrefA , MinQtDepthUsedrefL )$$

$$MinQtSizecur = Min ( MinQtSizeUsedrefA , MinQtSizeUsedrefL )$$

$$MaxBtSizecur = Max ( MaxBtSizeUsedrefA , MaxBtSizeUsedrefL )$$

$$MaxTtSizecur = Max ( MaxTtSizeUsedrefA , MaxTtSizeUsedrefL )$$

$$MinCbSizecur = Min ( MinCbSizeUsedrefA , MinCbSizeUsedrefL )$$

$$MinWidthcur = Min ( MinWidthUsedrefA , MinWidthUsedrefL )$$

$$MinHeightcur = Min ( MinHeightUsedrefA , MinHeightUsedrefL ) ,$$

For another example, a video coder may further utilize partition statistics from a temporal reference block, refT, to derive or predict the constraint parameters for a current block region, as follow:

$${MaxMttDepth}_{cur} = Max ( {MaxMttDepthUsed}_{refA} , {MaxMttDepthUsed}_{refL} , {MaxMttDepthUsed}_{refT} )$$

$${MaxQtDepth}_{cur} = Max ( {MaxQtDepthUsed}_{refA} , {MaxQtDepthUsed}_{refL} , {MaxQtDepthUsed}_{refT} )$$

$${MinQtDepth}_{cur} = Min ( {MinQtDepthUsed}_{refA} , {MinQtDepthUsed}_{refL} , {MinQtDepthUsed}_{refT} )$$

$${MinQtSize}_{cur} = Min ( {MinQtSizeUsed}_{refA} , {MinQtSizeUsed}_{refL} , {MinQtSizeUsed}_{refT} )$$

$${MaxBtSize}_{cur} = Max ( {MaxBtSizeUsed}_{refA} , {MaxBtSizeUsed}_{refL} , {MaxBtSizeUsed}_{refT} )$$

$${MaxTtSize}_{cur} = Max ( {MaxTtSizeUsed}_{refA} , {MaxTtSizeUsed}_{refL} , {MaxTtSizeUsed}_{refT} )$$

$${MinCbSize}_{cur} = Min ( {MinCbSizeUsed}_{refA} , {MinCbSizeUsed}_{refL} , {MinCbSizeUsed}_{refT} )$$

$${MinWidth}_{cur} = Min ( {MinWidthUsed}_{refA} , {MinWidthUsed}_{refL} , {MinWidthUsed}_{refT} )$$

$${MinHeight}_{cur} = Min ( {MinHeightUsed}_{refA} , {MinHeightUsed}_{refL} , {MinHeightUsed}_{refT} )$$

In some embodiments, a video coder may utilize partition information of one selected reference block to predict or derive a collection of constraint parameters for partitioning a current block region. For example, in some embodiments, a video coder may predict or derive the collection of constraint parameters for the current block region by copying the corresponding parameter values in the selected reference block. For example, a video coder may determine the values of MaxQtDepth and MinCbSize for a current block region according to the values of the corresponding parameters in the selected reference block by setting MaxQtDepth_{cur} and MinCbSize_{cur} equal to MaxQtDepth_{ref} and MinCbSize_{ref}, respectively. In another method, a video coder may predict or derive the collection of constraint parameters for the current block region according to the values of corresponding variables on related partition statistics in the selected reference block. For example, a video coder may determine the values of MaxQtDepth and MinCbSize for a current block region according to the values of the corresponding variables MaxQtDepthUsed and MinCbSizeUsed in the selected reference block by setting MaxQtDepth_{cur} equal to MaxQtDepthUsed_{ref} and MinCbSize_{cur} equal to MinCbSizeUsed_{ref}.

In some embodiments, a video coder may determine a value of a constraint parameter further based on the QP information in the current block region and the selected reference block(s). For example, a video coder may set the value of T_{minCS} dependent on QP information in the current block region and the selected reference block(s). In one embodiment, a video coder may set T_{minCS} equal to 1 when the QP value associated with the current block region is less than the QP value associated with the selected reference block by more than a specified threshold.

In some embodiments, a video coder may signal one or more syntax elements to identify the selected reference block from the candidate reference blocks for deriving or predicting a collection of constraint parameters enforced for a current block region. In some embodiments, the video coder may create a candidate reference CTU list that includes all reference CTUs that can be used for deriving or predicting the collection of constraint parameters enforced for partitioning a current CTU. The video coder may signal one or more syntax elements to indicate the selected reference CTU index in the candidate reference CTU list for deriving the collection of constraint parameters enforced for partitioning the current CTU.

In some embodiments, the candidate reference CTU list may include the above neighboring CTU, the left neighboring CTU, the top-left neighboring CTU, the top-right neighboring CTU, the temporal collocated CTU, or a combination thereof. The candidate reference CTU list may further include some spatially non-adjacent CTUs from the coded regions in a current picture. In some embodiments, a video coder may use different reference CTU lists for different collections of constraint parameters. For example, a video coder may use only spatial reference blocks for one collection of constraint parameters and only use temporal reference blocks for another collection of constraint parameters for partitioning a current block region.

In some embodiments, a video coder may perform redundancy removal for creating the candidate reference CTU list, such that the candidate reference CTU list does not include the CTUs with identical or similar partition statistics related to predicting a collection of constraint parameters for partitioning a current block region. For example, a video coder may perform a redundancy check step before adding a new candidate reference CTU to the candidate reference CTU list, in which the values of the related partition statistics of the new candidate reference CTU are compared with those of each CTU in the existing candidate reference CTU list for redundancy check. The new candidate reference CTU can be further added to the candidate reference CTU list only when no redundancy is found for comparison with each CTU in the existing candidate reference CTU list.

In some embodiments, the constraint parameters for a current block region may be derived by the related constraint parameters signaled in a current picture header (PH). For examples, MinQTSize, MaxBtSize, MaxTtSize, MaxMttDepth, and MinCbSize may be set equal to the corresponding parameter values specified in the picture header. When MaxMttDepth is greater than 0, BtEnabedFlag and TtEnabedFlag HorEnabledFlag and VerEnabledFlag are all set to true. Otherwise, they are all set to false. In some embodiments, the video coder may further comprise signaling one or more syntax elements to indicate if a collection of constraint parameters for a current block region are derived from the partition information of the selected one or more reference block or derived according to one or more pre-defined parameter settings, where one or more pre-defined parameter settings include the parameter setting derived from a current picture header.

In some embodiments, a video coder may signal additional syntax information for deriving the constraint parameters for the current block region. For example, a video coder may further signal syntax information for deriving some of the constraint parameters enforced for partitioning a current CTU. In some embodiments, a video coder may signal one or more syntax elements for deriving MaxMttDepth, MaxQtDepth, or MinCbSize enforced for a current CTU. Alternatively, in some other embodiments, a video coder may derive some of the constraint parameters for the current block region from the current picture header or from partition information on the selected one or more reference blocks. In some embodiments, a video coder may support more than one method for deriving some of the constraint parameters for partitioning a current CTU. The video coder may signal syntax information to indicate a selected method from multiple candidate methods for deriving a collection of constraint parameters enforced for partitioning a current CTU. In some embodiments, a video coder may signal one or more syntax elements to indicate (i) whether additional syntax information is signaled for the current CTU and (ii) whether the collection of constraint parameters are derived by such additional syntax information.

In some embodiments, a video coder may obey the partitioning constraint parameters specified by a current picture header for deriving the constraint parameters for a current block region. In some other embodiments, a video coder may override the partitioning constraint parameters specified by a current picture header for deriving the constraint parameters for a current block region.

In some embodiments, a video coder may also utilize information on block partitioning structures in one or more reference block regions for entropy coding one or more syntax elements related to derivation of the block partitioning structure for a current block region. One or more reference block regions may include one or more spatial neighboring block regions of the current block in the current picture and/or one or more temporal reference block regions from one or more coded reference pictures. For example, a video coder may entropy encode or decode a syntax element split_qt_flag to indicate whether a current CU is further partitioned by a QT split or a MTT split with context modeling further dependent on QT and/or MTT depth statistics in one or more temporal reference block regions. In some embodiments, context selection for entropy coding split_qt_flag may further consider the minimum, maximum and/or average of QT/MTT depth statistics for coded blocks in one or more temporal reference regions. In some embodiments, context selection for entropy coding split_qt_flag may be further dependent on the maximum QT depth MaxQtDepthUsed_{colCTU} and/or minimum QT depth MinQtDepthUsed_{colCTU} for a collocated temporal reference CTU. In some embodiments, context selection for entropy coding split_qt_flag may be further dependent on the QT depth for a collocated temporal reference block.

For another example, in some embodiments, a video coder may entropy encode or decode a syntax element split_vertical_flag to indicate whether a current CU is further partitioned by a vertical split or a horizontal split. The entropy coding uses context modeling that is dependent on information about block shapes or split directions for the coded blocks in one or more temporal reference block regions. In some embodiments, context selection for entropy coding split_vertical_flag may further consider whether horizontal split or vertical split is ever applied in one or more temporal reference regions. In one specific embodiment, context selection for entropy coding split_vertical flag may further depend on HorUsedFlag_{colCTU} and VerUsedFlag_{colCTU}, where HorUsedFlag_{colCTU} and VerUsedFlag_{colCTU} respectively indicate whether a horizontal split and/or vertical split is/are used in a collocated temporal reference CTU. In some embodiments, context selection for entropy coding split_vertical flag may further consider block split direction, shape, and/or size for a collocated temporal reference block.

For another example, in some embodiments, a video coder may entropy encode or decode a syntax element split_cu_flag to indicate whether a current CU is further partitioned. The entropy coding uses context modeling that is dependent on information related to QT/MTT depths and/or blocks sizes for coded blocks in one or more temporal reference regions. In one specific embodiment, context selection for entropy coding split_cu_flag may be further dependent on the minimum CB size MinCbSizeUsed_{colCTU} and/or minimum QT depth MinQtDepthUsed_{colCTU} for a collocated temporal reference CTU. In some embodiments, context selection for entropy coding split_cu_flag may be further dependent on the block size for a collocated temporal reference block.

For another example, in some embodiments, a video coder may entropy encode or decode the partitioning constraint parameters such as MinQtSize, MaxBtSize, MaxTtSize, MaxMttDepth, MinCbSize, MaxQtDepth, MinQtDepth, MinWidth, MinHeight, BtEnabedFlag, TtEnabledFlag, HorEnabledFlag, and VerEnabledFlag for a current block region. The entropy coding uses context modeling that is dependent on the related partitioning constraint parameters MinQtSizeUsed, MaxBtSizeUsed, MaxTtSizeUsed, MaxMttDepthUsed, MinCbSizeUsed, MaxQtDepthUsed, MinQtDepthUsed, MinWidthUsed, MinHeightUsed, BtUsedFlag, TtUsedFlag, HorUsedFlag, and VerUsedFlag, respectively, in one or more reference blocks. In some embodiments, context selection for entropy coding the constraint parameters MaxQtDepth_{curCTU}, MinQtDepth_{curCTU}, MaxMttDepth_{curCTU}, and MinCbSize_{curCTU} for a current CTU may be dependent on the constraint parameters MaxQtDepthUsed_{colCTU}, MinQtDepthUsed_{colCTU}, MaxMttDepthUsed_{colCTU}, and MinCbSizeUsed_{colCTU}, respectively, for the collocated temporal reference CTU.

In some embodiments, when a video encoder applies rate-distortion optimization, statistics of partitioning structures are often corelated with quantization parameters adopted for coding block regions. In some embodiments, the video coder may also utilize information on quantization parameters adopted by a current block region and one or more reference block regions for entropy coding one or more syntax elements related to derivation of the block partitioning structure for the current block region. For example, in some embodiments, context selection for entropy coding split_qt_flag may be dependent on the maximum QT depth MaxQtDepthUsed_{colCTU} and/or minimum QT depth MinQtDepthUsed_{colCTU} and further jointly dependent on the adopted quantization parameter for the current block and the average quantization parameter value for a collocated temporal reference CTU. In another example, context selection for entropy coding the constraint parameters MaxQtDepth_{curCTU}, MinQtDepth_{curCTU}, MaxMttDepth_{curCTU}, and MinCbSize_{curCTU} for a current CTU may be dependent on the constraint parameters MaxQtDepthUsed_{colCTU}, MinQtDepthUsed_{colCTU}, MaxMttDepthUsed_{colCTU}, and MinCbSizeUsed_{colCTU}, respectively, and further jointly dependent on the adopted quantization parameter for the current CTU and the average quantization parameter value for the collocated temporal reference CTU.

The method of signaling and coding block partitioning information based on reference block regions described above may further include signaling one or more syntax elements in one or more high-level syntax sets to indicate whether the above-described methods is enabled or disable in a current video data unit. The high-level syntax sets may include SPS, PPS, PH, SH, or a combination thereof.

Any of the foregoing proposed methods can be implemented in encoders and/or decoders. For example, any of the proposed methods can be implemented in a CU partitioning module of an encoder, and/or a CU partitioning module of a decoder. Alternatively, any of the proposed methods can be implemented as a circuit integrated to the CU partitioning module of the encoder and/or the CU partitioning module of the decoder. The proposed aspects, methods and related embodiments can be implemented individually or jointly in an image and video coding system.

### III. Example Video Encoder

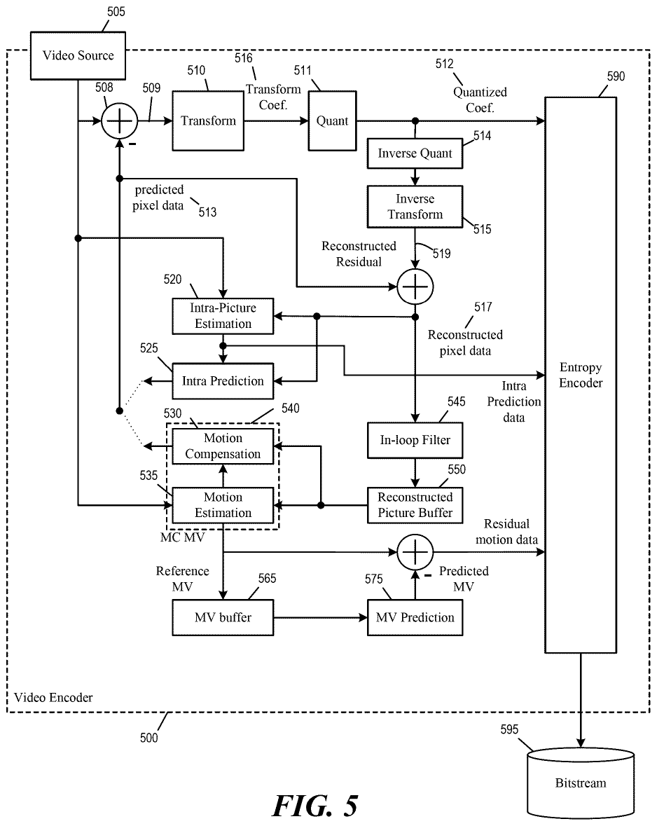

FIG. 5 illustrates an example video encoder 500 that may signal block partition information based on reference regions information. As illustrated, the video encoder 500 receives input video signal from a video source 505 and encodes the signal into bitstream 595. The video encoder 500 has several components or modules for encoding the signal from the video source 505, at least including some components selected from a transform module 510, a quantization module 511, an inverse quantization module 514, an inverse transform module 515, an intra-picture estimation module 520, an intra-prediction module 525, a motion compensation module 530, a motion estimation module 535, an in-loop filter 545, a reconstructed picture buffer 550, a MV buffer 565, and a MV prediction module 575, and an entropy encoder 590. The motion compensation module 530 and the motion estimation module 535 are part of an inter-prediction module 540.

In some embodiments, the modules 510-590 are modules of software instructions being executed by one or more processing units (e.g., a processor) of a computing device or electronic apparatus. In some embodiments, the modules 510-590 are modules of hardware circuits implemented by one or more integrated circuits (ICs) of an electronic apparatus. Though the modules 510-590 are illustrated as being separate modules, some of the modules can be combined into a single module.

The video source 505 provides a raw video signal that presents pixel data of each video frame without compression. A subtractor 508 computes the difference between the raw video pixel data of the video source 505 and the predicted pixel data 513 from the motion compensation module 530 or intra-prediction module 525 as prediction residual 509. The transform module 510 converts the difference (or the residual pixel data or residual signal 508) into transform coefficients (e.g., by performing Discrete Cosine Transform, or DCT). The quantization module 511 quantizes the transform coefficients into quantized data (or quantized coefficients) 512, which is encoded into the bitstream 595 by the entropy encoder 590.

The inverse quantization module 514 de-quantizes the quantized data (or quantized coefficients) 512 to obtain transform coefficients, and the inverse transform module 515 performs inverse transform on the transform coefficients to produce reconstructed residual 519. The reconstructed residual 519 is added with the predicted pixel data 513 to produce reconstructed pixel data 517. In some embodiments, the reconstructed pixel data 517 is temporarily stored in a line buffer (not illustrated) for intra-picture prediction and spatial MV prediction. The reconstructed pixels are filtered by the in-loop filter 545 and stored in the reconstructed picture buffer 550. In some embodiments, the reconstructed picture buffer 550 is a storage external to the video encoder 500. In some embodiments, the reconstructed picture buffer 550 is a storage internal to the video encoder 500.

The intra-picture estimation module 520 performs intra-prediction based on the reconstructed pixel data 517 to produce intra prediction data. The intra-prediction data is provided to the entropy encoder 590 to be encoded into bitstream 595. The intra-prediction data is also used by the intra-prediction module 525 to produce the predicted pixel data 513.

The motion estimation module 535 performs inter-prediction by producing MVs to reference pixel data of previously decoded frames stored in the reconstructed picture buffer 550. These MVs are provided to the motion compensation module 530 to produce predicted pixel data.

Instead of encoding the complete actual MVs in the bitstream, the video encoder 500 uses MV prediction to generate predicted MVs, and the difference between the MVs used for motion compensation and the predicted MVs is encoded as residual motion data and stored in the bitstream 595.

The MV prediction module 575 generates the predicted MVs based on reference MVs that were generated for encoding previously video frames, i.e., the motion compensation MVs that were used to perform motion compensation. The MV prediction module 575 retrieves reference MVs from previous video frames from the MV buffer 565. The video encoder 500 stores the MVs generated for the current video frame in the MV buffer 565 as reference MVs for generating predicted MVs.

The MV prediction module 575 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 595 by the entropy encoder 590.

The entropy encoder 590 encodes various parameters and data into the bitstream 595 by using entropy-coding techniques such as context-adaptive binary arithmetic coding (CABAC) or Huffman encoding. The entropy encoder 590 encodes various header elements, flags, along with the quantized transform coefficients 512, and the residual motion data as syntax elements into the bitstream 595. The bitstream 595 is in turn stored in a storage device or transmitted to a decoder over a communications medium such as a network.

The in-loop filter 545 performs filtering or smoothing operations on the reconstructed pixel data 517 to reduce the artifacts of coding, particularly at boundaries of pixel blocks. In some embodiments, the filtering or smoothing operations performed by the in-loop filter 545 include deblock filter (DBF), sample adaptive offset (SAO), and/or adaptive loop filter (ALF).

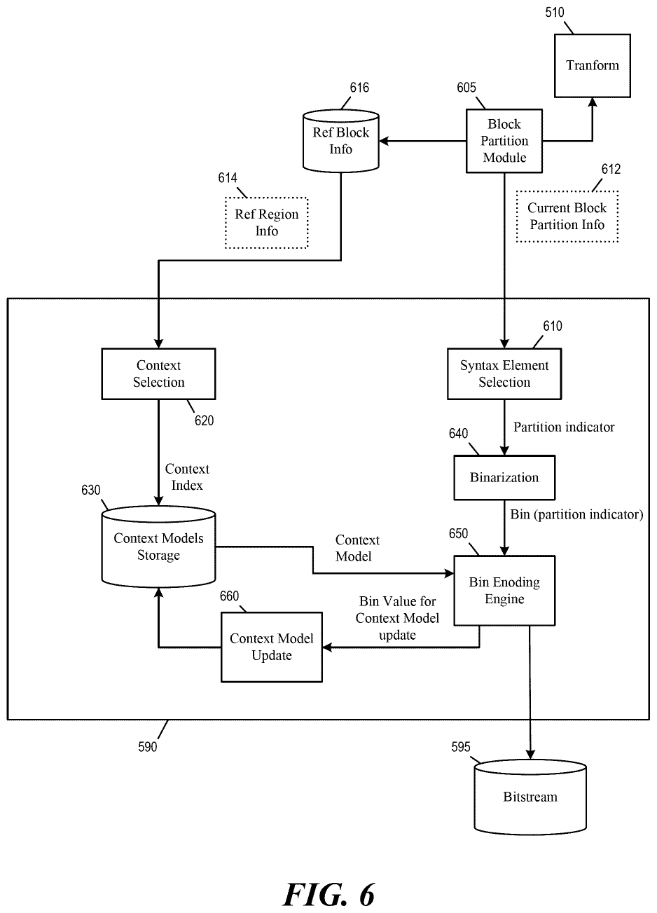

FIG. 6 illustrates portions of the video encoder 500 that signals block partition information based on reference region information. Specifically, the figure illustrates the components of the entropy encoder 590 that are used to entropy encode syntax elements regarding block partitioning information of the current block.

As illustrated, the entropy encoder 590 includes a syntax element selection module 610, a context selection module 620, a context models storage 630, a binarization module 640, a bin encoding engine 650, and a context model update module 660.

The syntax element selection module 610 selects data to be entropy encoded as syntax elements in the bitstream 595 from various sources of the video encoder 500. Such data may include current block partitioning information 612, which may be provided by a block partitioning module 605 that controls block partitioning in the transform module 510. The current block partition information 612 includes information that specifies the block partitioning structure of the current block. The current block partitioning information 612 may include indication for whether the current block is further partitioned (e.g., split_cu_flag), whether the current block is further partitioned by a QT or MTT split (e.g., split_qt_flag), whether the current block is split horizontally or vertically (split_vertical_flag or split_horizontal_flag). The current block partitioning information 612 may also include partitioning constraint parameters (described in Section II above) that are enforced upon the partitioning structure of the current block.

The data selected as syntax element is passed to the binarization module 640, which convert the selected data into bins. The bin encoding engine 650 in turn performs binary arithmetic coding to convert the bins into binary arithmetic codes to be included in the bitstream 595. The binary arithmetic coding operation relies on context modeling, which provides a context model based on probabilities specific to the type of syntax element being coded. The different context models of the different types of syntax elements are stored at the context models storage 630. The context model update module 660 updates the probabilities of the various context models based on the bin values that are processed at the bin encoding engine 650. The context model being used by the bin encoding engine 650 is retrieved from the context models storage 630 based on a context index provided by the context selection module 620.

The context selection module 620 selects context modeling based on information provided by various sources of the video encoder 500. Such information includes reference region information 614, which are stored information regarding already reconstructed blocks in the current picture or reference pictures, whether they are used for motion compensation or not. These reference regions may include spatial neighbor blocks, spatial non-adjacent blocks, and temporal reference blocks. Reference region information 614 may include QT depths, blocks sizes, split directions, block shapes, partition constraint parameters of one or more reference regions. The context selection module 620 may perform comparison of these parameters with analogous parameters of the current block when selecting a context for entropy encoding.

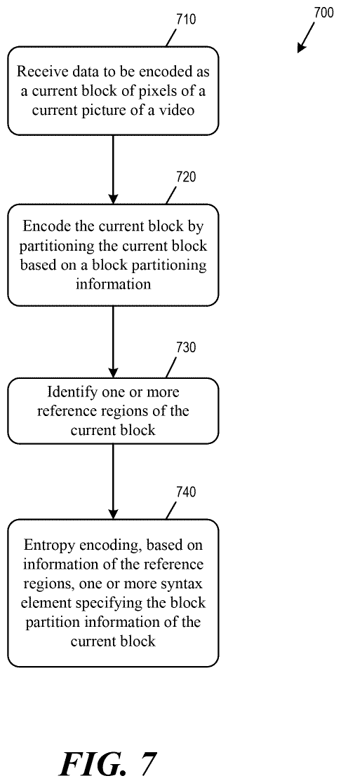

FIG. 7 conceptually illustrates a video encoding process 700 that signals block partition information based on reference region information. In some embodiments, one or more processing units (e.g., a processor) of a computing device implementing the encoder 500 performs the process 700 by executing instructions stored in a computer readable medium. In some embodiments, an electronic apparatus implementing the encoder 500 performs the process 700.

The encoder receives (at block 710) data to be encoded as a current block of pixels in a current picture.

The encoder encodes (at block 720) the current block by partitioning the block based on a block partitioning information, which may specify a partitioning structure based on quad tree splitting and/or multi-type tree splitting. Each partition may be encoded by one or more prediction mode to produce prediction residuals.

Then encoder identifies (at block 730) one or more reference regions of the current block. The one or more reference regions comprise one or more blocks that spatially neighbor the current block, or blocks that are in the current picture but not adjacent to the current block, or collocated temporal reference blocks in one or more coded reference pictures. These reference regions may correspond to merge candidates of the current block. The identified reference regions may or may not be used for motion compensation or other predictive coding of the current block.

The encoder entropy encodes (at block 740) one or more syntax elements specifying the block partitioning information of the current block. The entropy coding is performed based on information regarding the one or more reference regions of the current block. The one or more syntax elements may be entropy coded with context modeling selected based on the information regarding the one or more reference regions.

The block partitioning related syntax element being entropy coded may be one that is used to indicate whether the current block (e.g., CU) is further partitioned (e.g., split_cu_flag) or is used to indicate whether the current block is further partitioned by a quad tree (QT) split or a multi-type tree split (MTT) (e.g., split_qt_flag.) The syntax element may be entropy coded with context modeling selected based on QT or MTT split depth statistics, or based on a comparison of a QT depth of the current block with a minimum, a maximum, or an average of QT depths of the one or more reference regions, or based on a comparison of a QT depth of the current block with a QT depth of a collocated temporal reference block, or based on blocks sizes of one or more temporal reference regions.

The block partitioning related syntax element being entropy coded may also be one that is used to indicate whether a current CU is further partitioned by a vertical split or a horizontal split (e.g., split_vertical/horizontal_flag.) The syntax element may be entropy coded with context modeling selected based on information regarding block shapes, split directions, or block sizes of one or more temporal reference block regions, or based on whether vertical split or horizontal split is ever applied in one or more temporal reference regions.

The block partitioning related syntax element (or elements) being entropy coded may also be used to indicate a set of partitioning constraint parameters that is enforced upon the block partitioning structure of the current block. The syntax elements may be entropy coded with context modeling selected based on partitioning constraint parameters of the one or more spatial or temporal reference regions. In some embodiments, the set of partitioning constraint parameters of the current block may be derived based on block partitioning information of the one or more spatial or temporal reference regions.

### IV. Example Video Decoder

In some embodiments, an encoder may signal (or generate) one or more syntax element in a bitstream, such that a decoder may parse said one or more syntax element from the bitstream.

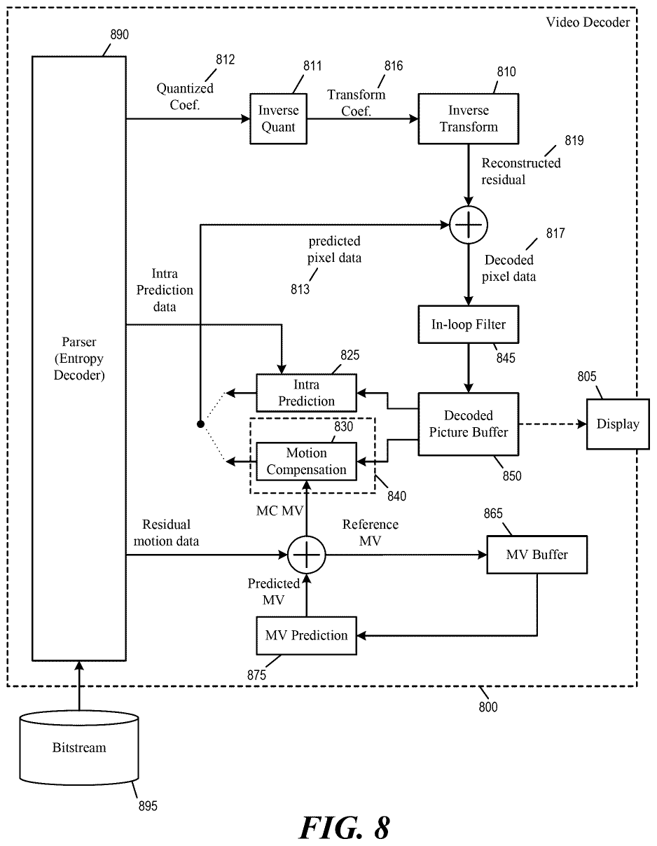

FIG. 8 illustrates an example video decoder 800 that may signal block partitioning information based on reference regions information. As illustrated, the video decoder 800 is an image-decoding or video-decoding circuit that receives a bitstream 895 and decodes the content of the bitstream into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more ICs of an electronic apparatus. Though the modules 810-890 are illustrated as being separate modules, some of the modules can be combined into a single module.

The parser 890 (or entropy decoder) receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer (not illustrated) for intra-picture prediction and spatial MV prediction.

In some embodiments, the content of the decoded picture buffer 850 is used for display. A display device 805 either retrieves the content of the decoded picture buffer 850 for display directly, or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data received from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering or smoothing operations performed by the in-loop filter 845 include deblock filter (DBF), sample adaptive offset (SAO), and/or adaptive loop filter (ALF).

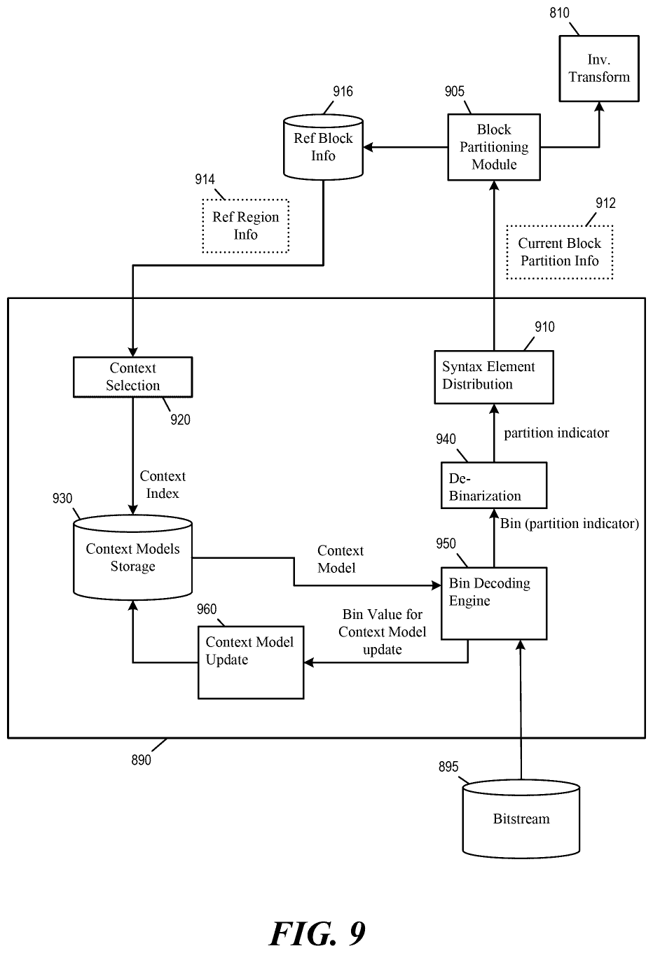

FIG. 9 illustrates portions of the video decoder 800 that receives block partition information based on reference regions information. Specifically, the figure illustrates the components of the entropy decoder 890 when entropy decoding a transform block of the current block.

As illustrated, the entropy decoder 890 includes a syntax element distribution module 910, a context selection module 920, a context models storage 930, a de-binarization module 940, a bin decoding engine 950, and a context model update module 960.

The bin decoding engine 950 receives bits from the bitstream 895 and performs binary arithmetic coding to convert the received bits into bins. The binary arithmetic coding operation relies on context modeling, which provides a context model based on probabilities specific to the type of syntax element being coded.

The different context models of the different types of syntax elements are stored at the context models storage 930. The context model update module 960 updates the probabilities of the various context models based on the bin values that are processed at the bin decoding engine 950. The de-binarization module 940 converts the bins into syntax elements. The decoded syntax elements are in turn distributed to various destinations in the video decoder 800 by the syntax element distribution module 910. As illustrated, some of the decoded syntax elements are used as current block partitioning information 912,
which may be provided to a block partitioning module 905 that controls block partitioning in the inverse transform module 810. The current block partition information 912 includes information that specifies the block partitioning structure of the current block. The current block partitioning information 912 may include indication for whether the current block is further partitioned (e.g., split_cu_flag), whether the current block is further partitioned by a QT or MTT split (e.g., split_qt_flag), whether the current block is split horizontally or vertically (split_vertical_flag or split_horizontal_flag). The current block partitioning information 912 may also include partitioning constraint parameters (described in Section II above) that are enforced upon the partitioning structure of the current block.

The context model being used by the bin decoding engine 950 is retrieved from the context models storage 930 based on context index provided by the context selection module 920. The context selection module 920 selects context modeling based on information provided by various sources of the video decoder 800. Such information includes reference region information 914, which are stored information regarding already coded blocks in the current picture or reference pictures, whether they are used for motion compensation or not. These reference regions may include spatial neighbor blocks, spatial non-adjacent blocks, and temporal reference blocks. Reference region information 914 may include QT depths, blocks sizes, split directions, block shapes, partition constraint parameters of one or more reference regions. The context selection module 920 may perform comparison of these parameters with analogous parameters of the current block when selecting a context for entropy decoding.

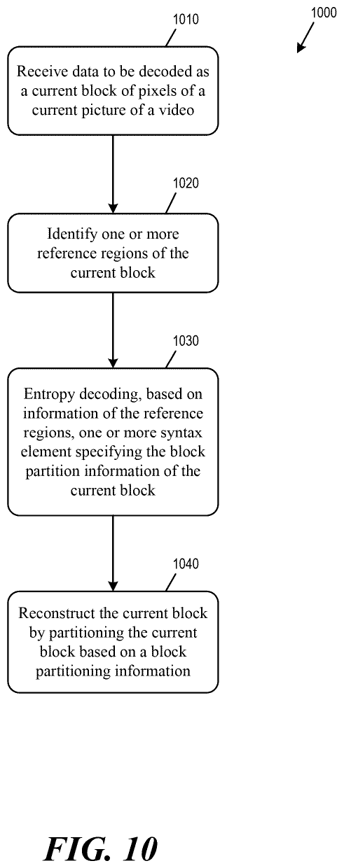

FIG. 10 conceptually illustrates a video decoding process 1000 that receives block partition information based on reference region information. In some embodiments, one or more processing units (e.g., a processor) of a computing device implementing the decoder 800 performs the process 1000 by executing instructions stored in a computer readable medium. In some embodiments, an electronic apparatus implementing the decoder 800 performs the process 1000.

The decoder receives (at block 1010) data to be decoded as a current block of pixels in a current picture.

Then decoder identifies (at block 1020) one or more reference regions of the current block. The one or more reference regions comprise one or more blocks that spatially neighbor the current block, or blocks that are in the current picture but not adjacent to the current block, or collocated temporal reference blocks in one or more coded reference pictures. These reference regions may correspond to merge candidates of the current block. The identified reference regions may or may not be used for motion compensation or other predictive coding of the current block.

The decoder entropy decodes (at block 1030) one or more syntax elements specifying the block partitioning information of the current block. The entropy coding is performed based on information regarding the one or more reference regions of the current block. The one or more syntax elements may be entropy coded with context modeling selected based on the information regarding the one or more reference regions.

The block partitioning related syntax element being entropy coded may be one that is used to indicate whether the current block (e.g., CU) is further partitioned (e.g., split_cu_flag) or is used to indicate whether the current block is further partitioned by a quad tree (QT) split or a multi-type tree split (MTT) (e.g., split_qt_flag.) The syntax element may be entropy coded with context modeling selected based on QT or MTT split depth statistics, or based on a comparison of a QT depth of the current block with a minimum, a maximum, or an average of QT depths of the one or more reference regions, or based on a comparison of a QT depth of the current block with a QT depth of a collocated temporal reference block, or based on blocks sizes of one or more temporal reference regions.

The block partitioning related syntax element being entropy coded may also be one that is used to indicate whether a current CU is further partitioned by a vertical split or a horizontal split (e.g., split_vertical/horizontal_flag.) The syntax element may be entropy coded with context modeling selected based on information regarding block shapes, split directions, or block sizes of one or more temporal reference block regions, or based on whether vertical split or horizontal split is ever applied in one or more temporal reference regions.

The block partitioning related syntax element (or elements) being entropy coded may also be used to indicate a set of partitioning constraint parameters that is enforced upon the block partitioning structure of the current block. The syntax elements may be entropy coded with context modeling selected based on partitioning constraint parameters of the one or more spatial or temporal reference regions. In some embodiments, the set of partitioning constraint parameters of the current block may be derived based on block partitioning information of the one or more spatial or temporal reference regions.

The decoder reconstructs (at block 1040) the current block by partitioning the current block based on a block partitioning information, which may specify a partitioning structure based on quad tree splitting and/or multi-type tree splitting. Each partition may be reconstructed using one or more prediction mode and the corresponding residual. The decoder may then provide the reconstructed current block for display as part of the reconstructed current picture.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

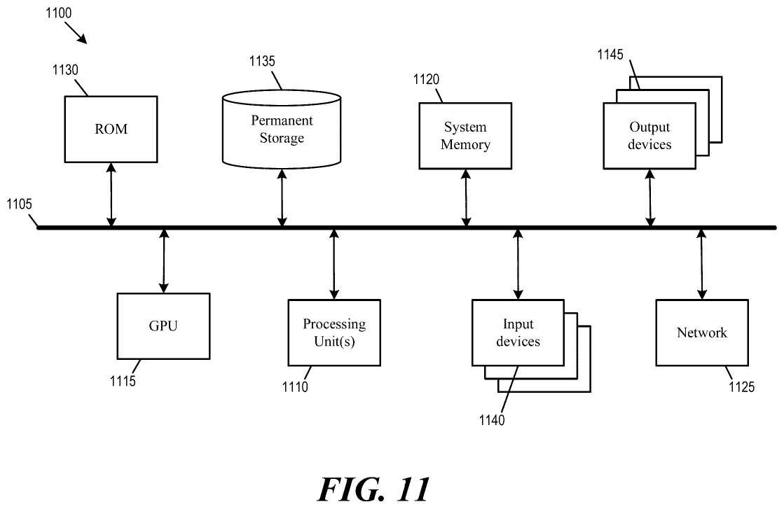

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 7 and FIG. 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
encoding or decoding the current block by partitioning the current block based on a block partitioning information; and
entropy coding one or more syntax elements specifying the block partitioning information of the current block, wherein the entropy coding is performed based on information regarding one or more reference regions of the current block.

2. The video coding method of claim 1, wherein the one or more syntax elements are entropy coded with context modeling selected based on the information regarding the one or more reference regions.

3. The video coding method of claim 1, wherein the one or more reference regions comprise one or more blocks that spatially neighbor the current block.

4. The video coding method of claim 1, wherein the one or more reference regions comprise one or more blocks that are in the current picture but not adjacent to the current block.

5. The video coding method of claim 1, wherein the one or more reference regions comprise one or more collocated temporal reference blocks in one or more coded reference picture.

6. The video coding method of claim 1, wherein the syntax element being entropy coded is used to indicate whether the current block is further partitioned.

7. The video coding method of claim 6, wherein the syntax element being entropy coded is used to indicate whether the current block is further partitioned by a quad tree (QT) split or a multi-type tree split (MTT).

8. The video coding method of claim 7, wherein the syntax element is entropy coded with context modeling selected based on QT or MTT split depth statistics.

9. The video coding method of claim 7, wherein the syntax element is entropy coded with context modeling selected based on a comparison of a QT depth of the current block with a minimum, a maximum, or an average of QT depths of the one or more reference regions.

10. The video coding method of claim 7, wherein the syntax element is entropy coded with context modeling selected based on a comparison of a QT depth of the current block with a QT depth of a collocated temporal reference block.

11. The video coding method of claim 6, wherein the syntax element is entropy coded with context modeling selected based on blocks sizes of the one or more reference regions.

12. The video coding method of claim 1, wherein the syntax element being entropy coded is used to indicate whether a current CU is further partitioned by a vertical split or a horizontal split.

13. The video coding method of claim 12, wherein the syntax element is entropy coded with context modeling selected based on information regarding block shapes, split directions, or block sizes of the one or more reference regions.

14. The video coding method of claim 12, wherein the syntax element is entropy coded with context modeling selected based on whether vertical split or horizontal split is ever applied in the one or more reference regions.

15. The video coding method of claim 1, wherein the syntax element being entropy coded is used to indicate a set of partitioning constraint parameters that is enforced upon the block partitioning structure of the current block.

16. The video coding method of claim 15, wherein the syntax element is entropy coded with context modeling selected based on partitioning constraint parameters of the one or more reference regions.

17. The video coding method of claim 15, wherein the set of partitioning constraint parameters of the current block is derived based on block partition information of the one or more reference regions.

18. An electronic apparatus comprising:
a video coder circuit configured to perform operations comprising:
receiving data to be encoded or decoded as a current block of pixels of a current picture of a video;
encoding or decoding the current block by partitioning the current block based on a block partitioning information; and
entropy coding one or more syntax elements specifying the block partitioning information of the current block, wherein the entropy coding is performed based on information regarding one or more reference regions of the current block.
